(19) United States
(12) Patent Application Publication
(10) Pub. No.: US 2022/0138556 A1
(43) Pub. Date: May 5, 2022

(54) DATA LOG PARSING SYSTEM AND METHOD

(71) Applicant: NVIDIA Corporation, Santa Clara, CA (US)

(72) Inventors: Bartley Douglas Richardson, Alexandria, VA (US); Rachel Kay Allen, Arlington, VA (US); Joshua Sims Patterson, Mount Pleasant, SC (US)

(21) Appl. No.: 17/089,019

(22) Filed: Nov. 4, 2020

(51) Int. Cl. G06N 3/08; G06F 16/25; G06F 40/205; G06F 40/284

(52) U.S. Cl. CPC G06N 3/08; G06F 40/284; G06F 40/205; G06F 16/258

(57) ABSTRACT

A method of processing data logs, a system for processing data logs, a method of training a system for processing data logs, and a processor are described. The method of processing data logs may include receiving a data log from a data source, where the data log is received in a format native to a machine that generated the data log. The method may also include providing the data log to a neural network trained to process natural language-based inputs, parsing the data log with the neural network, and receiving an output from the neural network, where the output is generated in response to the neural network parsing the data log. The method may also include storing the output from the neural network in a data log repository.

### FIELD OF THE DISCLOSURE

The present disclosure is generally directed toward data logs and, in particular, toward parsing data logs of known or unknown formats.

### BACKGROUND

Data logs were initially developed as a mechanism to maintain historical information about important events. As an example, bank transactions needed to be recorded for verification and auditing purposes. With developments in technology and the proliferation of the Internet, data logs have become more prevalent and any data generated by a connected device is often stored in some type of data log.

As an example, cybersecurity logs generated for an organization may include data generated by endpoints, network devices, and perimeter devices. Even small organizations can expect to generate hundreds of Gigabytes of data in log traffic. Even a minor data loss may result in security vulnerabilities for the organization.

### BRIEF SUMMARY

Traditional systems designed to ingest data logs are incapable of handling the current volume of data generated in most organizations. Furthermore, these traditional systems are not scalable to support significant increases in data log traffic, which often leads to missing or dropped data. In the context of cybersecurity logs, any amount of dropped or lost data may result in security exposures. Today, organizations collect, store, and try to analyze more data than ever before. Data logs are heterogeneous in source, format, and time. To complicate matters further, data log types and formats are constantly changing, which means that new types of data logs are being introduced to systems and many of these systems are not designed to handle such changes without significant human intervention. To summarize, traditional data log processing systems are ill equipped to properly handle the amount of data being generated in many organizations.

Embodiments of the present disclosure aim to solve the above-noted shortcomings and other issues associated with data log processing. Embodiments described herein provide a flexible, Artificial Intelligence (AI)-enabled system that is configured to handle large volumes of data logs in known or unknown formats.

In some embodiments, the AI-enabled system may leverage Natural Language Processing (NLP) as a technique for processing data logs. NLP is traditionally used for applications such as text translation, interactive chatbots, and virtual assistants. Turning to NLP to process data logs generated by machines does not immediately seem viable. However, embodiments of the present disclosure recognize the unique ability of NLP or other natural language-based neural networks, if trained properly, to parse data logs of known or unknown formats. Embodiments of the present disclosure also enable a natural language-based neural network to parse partial data logs, incomplete data logs, degraded data logs, and data logs of various sizes.

In an illustrative example, a method for processing data logs is disclosed that includes: receiving a data log from a data source, where the data log is received in a format native to a machine that generated the data log; providing the data log to a neural network trained to process natural language-based inputs; parsing the data log with the neural network; receiving an output from the neural network, where the output from the neural network is generated in response to the neural network parsing the data log; and storing the output from the neural network in a data log repository.

In another example, a system for processing data logs is disclosed that includes: a processor and memory coupled with the processor, where the memory stores data that, when executed by the processor, enables the processor to: receive a data log from a data source, where the data log is received in a format native to a machine that generated the data log; parse the data log with a neural network trained to process natural language-based inputs; and store an output from the neural network in a data log repository, where the output from the neural network is generated in response to the neural network parsing the data log.

In yet another example, a method of training a system for processing data logs is disclosed that includes: providing a neural network with first training data, where the neural network includes a Natural Language Processing (NLP) machine learning model and where the first training data includes a first data log generated by a first type of machine; providing the neural network with second training data, where the second training data includes a second data log generated by a second type of machine; determining that the neural network has trained on the first training data and the second training data for at least a predetermined amount of time; and storing the neural network in computer memory such that the neural network is made available to process additional data logs.

In another example, a processor is provided that includes one or more circuits to use one or more natural language-based neural networks to parse one or more machine-generated data logs. The one or more circuits may correspond to logic circuits interconnected with one another in a Graphics Processing Unit (GPU). The one or more circuits may be configured to receive the one or more machine-generated data logs from a data source and generate an output in response to parsing the one or more machine-generated data logs, where the output is configured to be stored as part of a data log repository. In some examples, the one or more machine-generated data logs are received as part of a data stream and at least one of the machine-generated data logs may include a degraded log and an incomplete log.

Additional features and advantages are described herein and will be apparent from the following Description and the figures.

### BRIEF DESCRIPTION OF THE SEVERAL VIEWS OF THE DRAWINGS

The present disclosure is described in conjunction with the appended figures, which are not necessarily drawn to scale:

FIG. 1 is a block diagram depicting a computing system in accordance with at least some embodiments of the present disclosure;

FIG. 2 is a block diagram depicting a neural network training architecture in accordance with at least some embodiments of the present disclosure;

FIG. 3 is a flow diagram depicting a method of training a neural network in accordance with at least some embodiments of the present disclosure;

FIG. 4 is a block diagram depicting a neural network operational architecture in accordance with at least some embodiments of the present disclosure;

FIG. 5 is a flow diagram depicting a method of processing data logs in accordance with at least some embodiments of the present disclosure; and

FIG. 6 is a flow diagram depicting a method of pre-processing data logs in accordance with at least some embodiments of the present disclosure.

### DETAILED DESCRIPTION

The ensuing description provides embodiments only, and is not intended to limit the scope, applicability, or configuration of the claims. Rather, the ensuing description will provide those skilled in the art with an enabling description for implementing the described embodiments. It being understood that various changes may be made in the function and arrangement of elements without departing from the spirit and scope of the appended claims.

It will be appreciated from the following description, and for reasons of computational efficiency, that the components of the system can be arranged at any appropriate location within a distributed network of components without impacting the operation of the system.

Furthermore, it should be appreciated that the various links connecting the elements can be wired, traces, or wireless links, or any appropriate combination thereof, or any other appropriate known or later developed element(s) that is capable of supplying and/or communicating data to and from the connected elements. Transmission media used as links, for example, can be any appropriate carrier for electrical signals, including coaxial cables, copper wire and fiber optics, electrical traces on a PCB, or the like.

As used herein, the phrases “at least one,” “one or more,” “or,” and “and/or” are open-ended expressions that are both conjunctive and disjunctive in operation. For example, each of the expressions “at least one of A, B and C,” “at least one of A, B, or C,” “one or more of A, B, and C,” “one or more of A, B, or C,” “A, B, and/or C,” and “A, B, or C” means: A alone; B alone; C alone; A and B together; A and C together; B and C together; or A, B and C together.

The term “automatic” and variations thereof, as used herein, refers to any appropriate process or operation done without material human input when the process or operation is performed. However, a process or operation can be automatic, even though performance of the process or operation uses material or immaterial human input, if the input is received before performance of the process or operation. Human input is deemed to be material if such input influences how the process or operation will be performed. Human input that consents to the performance of the process or operation is not deemed to be “material.”

The terms “determine,” “calculate,” and “compute,” and variations thereof, as used herein, are used interchangeably and include any appropriate type of methodology, process, operation, or technique.

Various aspects of the present disclosure will be described herein with reference to drawings that are schematic illustrations of idealized configurations.

Unless otherwise defined, all terms (including technical and scientific terms) used herein have the same meaning as commonly understood by one of ordinary skill in the art to which this disclosure belongs. It will be further understood that terms, such as those defined in commonly used dictionaries, should be interpreted as having a meaning that is consistent with their meaning in the context of the relevant art and this disclosure.

As used herein, the singular forms “a,” “an,” and “the” are intended to include the plural forms as well, unless the context clearly indicates otherwise. It will be further understood that the terms “comprise,” “comprises,” and/or “comprising,” when used in this specification, specify the presence of stated features, integers, steps, operations, elements, and/or components, but do not preclude the presence or addition of one or more other features, integers, steps, operations, elements, components, and/or groups thereof. The term “and/or” includes any and all combinations of one or more of the associated listed items.

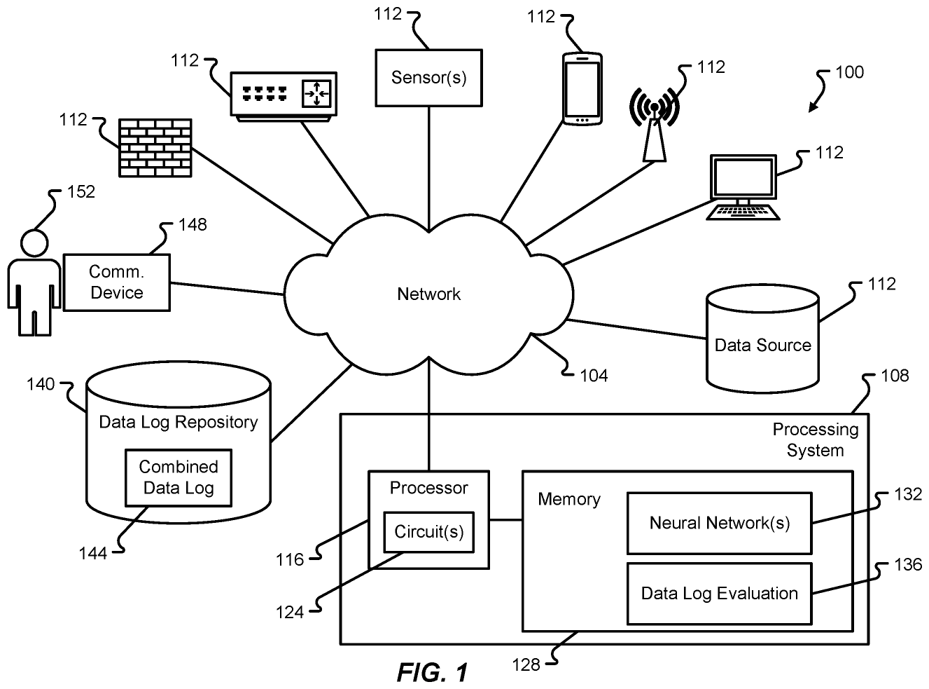

Referring now to FIGS. 1-6, various systems and methods for parsing data logs will be described. While various embodiments will be described in connection with utilizing AI, machine learning (ML), and similar techniques, it should be appreciated that embodiments of the present disclosure are not limited to the use of AI, ML, or other machine learning techniques, which may or may not include the use of one or more neural networks. Furthermore, embodiments of the present disclosure contemplate the mixed use of neural networks for certain tasks whereas algorithmic or predefined computer programs may be used to complete certain other tasks. Said another way, the methods and systems described or claimed herein can be performed with traditional executable instruction sets that are finite and operate on a fixed set of inputs to provide one or more defined outputs. Alternatively or additionally, methods and systems described or claimed herein can be performed using AI, ML, neural networks, or the like. In other words, a system or components of a system as described herein are contemplated to include finite instruction sets and/or AI-based models/neural networks to perform some or all of the processes or steps described herein.

In some embodiments, a natural language-based neural network is utilized to parse machine-generated data logs. The data logs may be received directly from the machine that generated the data log, in which case the machine itself may be considered a data source. The data logs may be received from a storage area that is used to temporarily store data logs of one or more machines, in which case the storage area may be considered a data source. In some embodiments, data logs may be received in real time, as part of a data stream transmitted directly from a data source to the natural language-based neural network. In some embodiments, data logs may be received at some point after they were generated by a machine.

Certain embodiments described herein contemplate the use of a natural language-based neural network. An example of a natural language-based neural network, or an approach that uses a natural language-based neural network, is NLP. Certain types of neural network word representations, like Word2vec, are context-free. Embodiments of the present disclosure contemplate the use of such context-free neural networks, which are capable of creating a single word-embedding for each word in the vocabulary and are unable to distinguish words with multiple meanings (e.g. the file on disk vs. single file line). More recent models (e.g., ULMFit and ELMo) have multiple representations for words based on context. These models achieve an understanding of context by using the word plus the previous words in the sentence to create the representations. Embodiments of the present disclosure also contemplate the use of context-based neural networks. A more specific, but non-limiting example of a neural network type that may be used without departing from the scope of the present disclosure is a Bidirectional Encoder Representations from Transformers (BERT) model. A BERT model is capable of creating contextual representations, but is also capable of taking into account the surrounding context in both directions—before and after a word. While embodiments will be described herein where a natural language-based neural network is used that has been trained on a corpus of data including English language words, sentences, etc., it should be appreciated that the natural language-based neural network may be trained on any data including any human language (e.g., Japanese, Chinese, Latin, Greek, Arabic, etc.) or collection of human languages.

Encoding contextual information (before and after a word) can be useful for understanding cyber logs and other types of machine-generated data logs because of their ordered nature. For example, across multiple data log types, a source address occurs before a destination address. BERT and other contextual-based NLP models can account for this contextual/ordered information.

An additional challenge of applying a natural language model to cyber logs and other types of machine-generated data logs is that many “words” in a cyber log are not English language words; they include things like file paths, hexadecimal values, and IP addresses. Other language models return an “out-of-dictionary” entry when faced with an unknown word, but BERT and similar other types of neural networks are configured to break down the words in cyber logs into in-dictionary WordPieces. For example, ProcessID becomes two in-dictionary WordPieces—Process and ##ID.

Diverse sets of data logs may be used for training one or more of the language-based neural networks described herein. For instance, data logs such as Windows event logs and apache web logs may be used as training data. The language of cyber logs is not the same as the English language corpus the BERT tokenizer and neural network were trained on.

A model's speed and accuracy may further be improved with the use of a tokenizer and representation trained from scratch on a large corpus of data logs. For example, a BERT WordPiece tokenizer may break down AccountDomain into A ##cco ##unt ##D ##oma ##in which is believed to be more granular than the meaningful WordPieces of AccountDomain in the data log language. The use of a tokenizer is also contemplated without departing from the scope of the present disclosure.

It may also be possible to configure a parser to move at network speed to keep up with the high volume of generated data logs. In some embodiments, preprocessing, tokenization, and/or post-processing may be executed on a Graphics Processing Unit (GPU) to achieve faster parsing without the need to communicate back and forth with host memory. It should be appreciated, however, that a Central Processing Unit (CPU) or other type of processing architecture may also be used without departing from the scope of the present disclosure.

Referring to FIGS. 1-6, an illustrative computing system 100 will be described in accordance with at least some embodiments of the present disclosure. A computing system 100 may include a communication network 104, which is configured to facilitate machine-to-machine communications. In some embodiments, the communication network 104 may enable communications between various types of machines, which may also be referred to herein as data sources 112. One or more of the data sources 112 may be provided as part of a common network infrastructure, meaning that the data sources 112 may be owned and/or operated by a common entity. In such a situation, the entity that owns and/or operates the network including the data sources 112 may be interested in obtaining data logs from the various data sources 112.

Non-limiting examples of data sources 112 may include communication endpoints (e.g., user devices, Personal Computers (PCs), computing devices, communication devices, Point of Service (PoS) devices, laptops, telephones, smartphones, tablets, wearables, etc.), network devices (e.g., routers, switches, servers, network access points, etc.), network border devices (e.g., firewalls, Session Border Controllers (SBCs), Network Address Translators (NATs), etc.), security devices (access control devices, card readers, biometric readers, locks, doors, etc.), and sensors (e.g., proximity sensors, motion sensors, light sensors, noise sensors, biometric sensors, etc.). A data source 112 may alternatively or additionally include a data storage area that is used to store data logs generated by various other machines connected to the communication network 104. The data storage area may correspond to a location or type of device that is used to temporarily store data logs until a processing system 108 is ready to retrieve and process the data logs.

In some embodiments, a processing system 108 is provided to receive data logs from the data sources 112 and parse the data logs for purposes of analyzing the content contained in the data logs. The processing system 108 may be executed on one or more servers that are also connected to the communication network 104. The processing system 108 may be configured to parse data logs and then evaluate/analyze the parsed data logs to determine if any of the information contained in the data logs includes actionable data events. The processing system 108 is depicted as a single component in the system 100 for ease of discussion and understanding. It should be appreciated that the processing system 108 and the components thereof (e.g., the processor 116, circuit(s) 124, and/or memory 128) may be deployed in any number of computing architectures. For instance, the processing system 108 may be deployed as a server, a collection of servers, a collection of blades in a single server, on bare metal, on the same premises as the data sources 112, in a cloud architecture (enterprise cloud or public cloud), and/or via one or more virtual machines.

Non-limiting examples of a communication network 104 include an Internet Protocol (IP) network, an Ethernet network, an InfiniBand (IB) network, a FibreChannel network, the Internet, a cellular communication network, a wireless communication network, combinations thereof (E.g., Fibre Channel over Ethernet), variants thereof, and the like.

As mentioned above, the data sources 112 may be considered host devices, servers, network appliances, data storage devices, security devices, sensors, or combinations thereof. It should be appreciated that the data source(s) 112 may be assigned at least one network address and the format of the network address assigned thereto may depend upon the nature of the network 104.

The processing system 108 is shown to include a processor 116 and memory 128. While the processing system 108 is only shown to include one processor 116 and one memory 128, it should be appreciated that the processing system 108 may include one or many processing devices and/or one or many memory devices. The processor 116 may be configured to execute instructions stored in memory 128 and/or the neural network 132 stored in memory 128. As some non-limiting examples, the memory 128 may correspond to any appropriate type of memory device or collection of memory devices configured to store instructions and/or instructions. Non-limiting examples of suitable memory devices that may be used for memory 128 include Flash memory, Random Access Memory (RAM), Read Only Memory (ROM), variants thereof, combinations thereof, or the like. In some embodiments, the memory 128 and processor 116 may be integrated into a common device (e.g., a microprocessor may include integrated memory).

In some embodiments, the processing system 108 may have the processor 116 and memory 128 configured as a GPU. The processor 116 may include one or more circuits 124 that are configured to execute a neural network 132 stored in memory 128. Alternatively or additionally, the processor 116 and memory 128 may be configured as a CPU. A GPU configuration may enable parallel operations on multiple sets of data, which may facilitate the real-time processing of one or more data logs from one or more data sources 112. If configured as a GPU, the circuits 124 may be designed with thousands of processor cores running simultaneously, where each core is focused on making efficient calculations. Additional details of a suitable, but non-limiting, example of a GPU architecture that may be used to execute the neural network(s) 132 are described in U.S. patent application Ser. No. 16/596,755 to Patterson et al., entitled “GRAPHICS PROCESSING UNIT SYSTEMS FOR PERFORMING DATA ANALYTICS OPERATIONS IN DATA SCIENCE”, the entire contents of which are hereby incorporated herein by reference.

Whether configured as a GPU and/or CPU, the circuits 124 of the processor 116 may be configured to execute the neural network(s) 132 in a highly efficient manner, thereby enabling real-time processing of data logs received from various data sources 112. As data logs are process/parsed by the processor 116 executing the neural network(s) 132, the outputs of the neural networks 132 may be provided to a data log repository 140.l In some embodiments, as various data logs in different data formats and data structures are processed by the processor 116 executing the neural network(s) 132, the outputs of the neural network(s) 132 may be stored in the data log repository 140 as a combined data log 144. The combine data log 144 may be stored as any format suitable for storing data logs or information from data logs. Non-limiting examples of formats used to store a combined data log 144 include spreadsheets, tables, delimited files, text files, and the like.

The processing system 108 may also be configured to analyze the data log(s) stored in the data log repository 140 (e.g., after the data logs received directly from the data sources 112 have been processed/parsed by the neural network(s) 132). The processing system 108 may be configured to analyze the data log(s) individually or as part of the combined data log 144 by executing a data log evaluation 136 with the processor 116. In some embodiments, the data log evaluation 136 may be executed by a different processor 116 than was used to execute the neural networks 132. Similarly, the memory device(s) used to store the neural network(s) 132 may or may not correspond to the same memory device(s) used to store the instructions of the data log evaluation 136. In some embodiments, the data log evaluation 136 is stored in a different memory device 128 than the neural network(s) 132 and may be executed using a CPU architecture as compared to using a GPU architecture to execute the neural networks 132.

In some embodiments, the processor 116, when executing the data log evaluation 136, may be configured to analyze the combined data log 144, detect an actionable event based on the analysis of the combined data log 144, and port the actionable event to a system administrator's 152 communication device 148. In some embodiments, the actionable event may correspond to detection of a network threat (e.g., an attack on the computing system 100, an existence of malicious code in the computing system 100, a phishing attempt in the computing system 100, a data breach in the computing system 100, etc.), a data anomaly, a behavioral anomaly of a user in the computing system 100, a behavioral anomaly of an application in the computing system 100, a behavioral anomaly of a device in the computing system 100, etc.

If an actionable data event is detected by the processor 116 when executing the data log evaluation 136, then a report or alert may be provided to the communication device 148 operated by a system administrator 152. The report or alert provided to the communication device 148 may include an identification of the machine/data source 112 that resulted in the actionable data event. The report or alert may alternatively or additionally provide information related to a time at which the data log was generated by the data source 112 that resulted in the actionable data event. The report or alert may be provided to the communication device 148 as one or more of an electronic message, an email, a Short Message Service (SMS) message, an audible indication, a visible indication, or the like. The communication device 148 may correspond to any type of network-connected device (e.g., PC, laptop, smartphone, cell phone, wearable device, PoS device, etc.) configured to receive electronic communications from the processing system 108 and render information from the electronic communications for a system administrator 152.

In some embodiments, the data log evaluation 136 may be provided as an alert analysis set of instructions stored in memory 128 and may be executable by the processor 116. A non-limiting example of the data log evaluation 136 is shown below:

```
import cudf
import s3fs
from os import path
# download data
if not path.exists(″./splunk_faker_raw4″):
  fs = s3fs.S3FileSystem(anon=True)
  fs.get(″rapidsai-data/cyber/clx/splunk_faker_raw4″, ″./splunk_faker_raw4″)
# read in alert data
gdf = cudf.read_csv(′./splunk_faker_raw4′)
gdf.columns = [′raw′]
# parse the alert data then return the parsed DF (dataframe) as well as the DF that
has the confidence scores
from clx.analytics.cybert import Cybert
logs_df = cudf.read_csv(LOG_FILE)
parsed_df, confidence_df = cybert.inference(logs_df[″raw″])
# define function to round time to the day
def round2day(epoch_time):
  return int(epoch_time/86400)*86400
# aggregate alerts by day
parsed_gdf[′time′] = parsed_gdf[′time′].astype(int)
parsed_gdf[′day′] = parsed_gdf.time.applymap(round2day)
day_rule_gdf= parsed_gdf[[′search_name′, ′day′, ′time′]].groupby([′search_name′,
′day′]) .count( ).reset_index( )
day_rule_gdf.columns = [′rule′, ′day′, ′count′]
# import the rolling z-score function from CLX statistics
from clx.analytics.stats import rzscore
# pivot the alert data so each rule is a column
def pivot_table(gdf, index_col, piv_col, v_col):
  index_list = gdf[index_col].unique( )
  piv_gdf = cudf.DataFrame( )
  piv_gdf[index_col] = index_list
  for group in gdf[piv_col].unique( ):
    temp_df = gdf[gdf[piv_col] == group]
    temp_df = temp_df[[index_col, v_col]]
    temp_df.columns = [index_col, group]
    piv_gdf = piv_gdf.merge(temp_df, on=[index_col], how=′left′)
  piv_gdf = piv_gdf.set_index(index_col)
  return piv_gdf.sort_index( )
alerts_per_day_piv = pivot_table(day_rule_gdf, ′day′, ′rule′, ′count′).fillna(0)
# create a new cuDF with the rolling z-score values calculated
r_zscores = cudf.DataFrame( )
for rule in alerts_per_day_piv.columns:
  x = alerts_per_day_piv[rule]
  r_zscores[rule] = rzscore(x, 7) #7 day window
```

The illustrative data log evaluation 136 code shown above, when executed by the processor 116, may enable the processor 116 to read cyber alerts, aggregate cyber alerts by day, and calculate the rolling z-score value across multiple days to look for outliers in volumes of alerts.

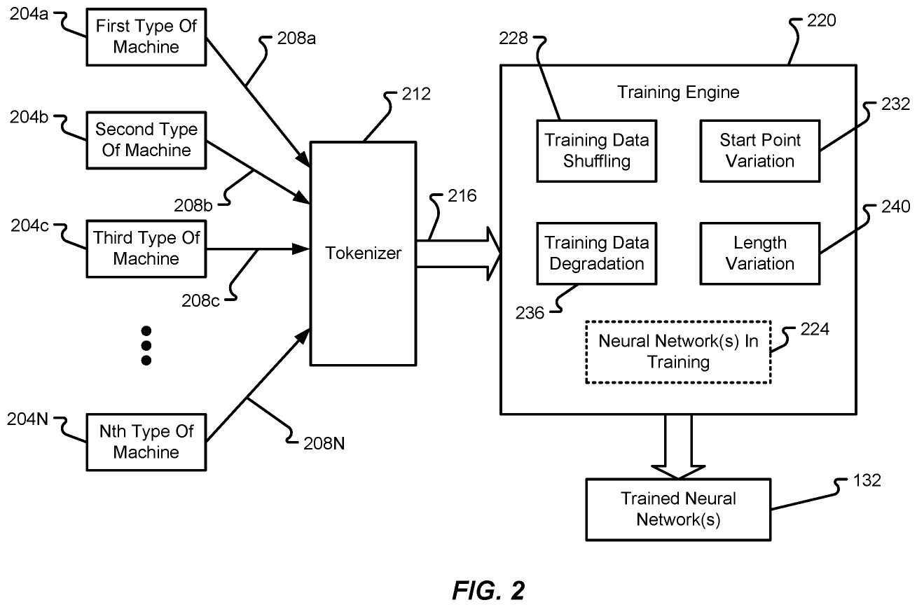

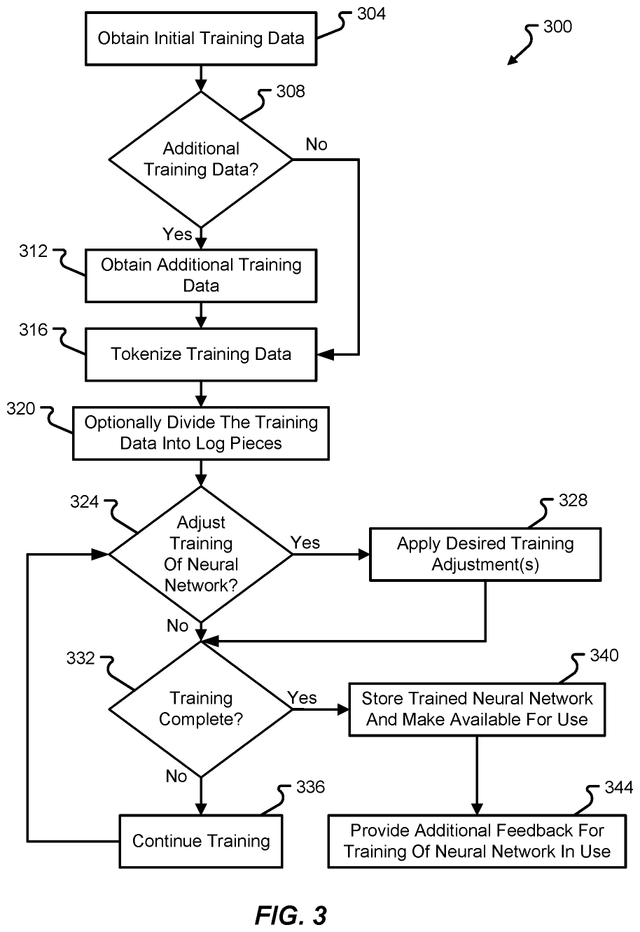

Referring now to FIGS. 2 and 3, additional details of a neural network training architecture and method will be described in accordance with at least some embodiments of the present disclosure. A neural network in training 224 may be trained by a training engine 220. Upon being sufficiently trained, the training engine 220 may eventually produce a trained neural network 132, which can be stored in memory 128 of the processing system 108 and used by the processor 116 to process/parse data logs from data sources 112.

The training engine 220, in some embodiments, may receive tokenized inputs 216 from a tokenizer 212. The tokenizer 212 may be configured to receive training data 208a-N from a plurality of different types of machines 204a-N. In some embodiments, each type of machine 204a-N may be configured to generate a different type of training data 208a-N, which may be in the form of a raw data log, a parsed data log, a partial data log, a degraded data log, a piece of a data log, or a data log that has been divided into many pieces. In some embodiments, each machine 204a-N may correspond to a different data source 112 and one or more of the different types of training data 208a-N may be in the form of a raw data log from a data source 112, a parsed data log from a data source 112, a partial data log. Whereas some training data 208a-N is received as a raw data log, other training data 208a-NB may be received as a parsed data log.

In some embodiments, the tokenizer 212 and training engine 220 may be configured to collectively process the training data 208a-N received from the different types of machines 204a-N. The tokenizer 212 may correspond to a subword tokenizer that supports non-truncation of logs/sentences. The tokenizer 212 may be configured to return encoded tensor, attention mask, and metadata to reform broken data logs. Alternatively or additionally, the tokenizer 212 may correspond to a wordpiece tokenizer, a sentencepiece tokenizer, a character-based tokenizer, or any other suitable tokenizer that is capable of tokenizing data logs into tokenized inputs 216 for the training engine 220.

As a non-limiting example, the tokenizer 212 and training engine 220 may be configured to train and test neural networks in training 224 on whole data logs that are all small enough to fit in one input sequence and achieve a micro-F1 score of 0.9995. However, a model trained in this way may not be capable of parsing data logs larger than the maximum model input sequence, and model performance may suffer when the data logs from the same testing set were changed to have variable starting positions (e.g., micro-F1: 0.9634) or were cut into smaller pieces (e.g., micro-F1: 0.9456). To stop the neural network in training 224 model from learning the absolute positions of the fields, it may be possible to train the neural network in training 224 on pieces of data logs. It may also be desirable to train the neural network in training 224 model on variable start points in data logs, degraded data logs, and data logs or log pieces of variable lengths. In some embodiments, the training engine 220 may include functionality that enables the training engine 220 to adjust one, some, or all of these characteristics of training data 208a-N (or the tokenized input 216) to enhance the training of the neural network in training 224 model. Specifically, but without limitation, the training engine 220 may include component(s) that enable training data shuffling 228, start point variation 232, training data degradation 236, and/or length variation 240. Adjustments to training data may result in similar accuracy to the fixed starting positions and the resulting trained neural network(s) 132 may perform well on log pieces of variable starting positions (e.g., micro-F1: 0.9938).

A robust and effective trained neural network 132 may be achieved when the training engine 220 trains the neural network in training 224 model on data log pieces. Testing accuracy of a trained neural network 132 may be measured by splitting each data log before inference into overlapping data log pieces, then recombining and taking the predictions from the middle half of each data log piece. This allows the model to have the most context in both directions for inference. When properly trained, the trained neural network 132 may exhibit the ability to parse data log types outside the training set (e.g., data log types different from the types of training data 208a-N used to train the neural network 132). When trained on just 1000 examples of each of nine different Windows event log types, a trained neural network 132 may be configured to accurately (e.g., micro-F1: 0.9645) parse a never seen before Windows event log type or a data log from a non-Windows data source 112.

FIG. 3 depicts an illustrative, but non-limiting, method 300 of training a neural network, which may correspond to a language-based neural network. The method 300 may be used to train an NLP machine learning model, which is one example of a neural network in training 224. The method 300 may be used to start with a pre-trained NLP model, that was originally trained on a corpus of data in a particular language (e.g., English, Japanese, German, etc.). When training a pre-trained NLP model (sometimes referred to as fine-tuning), the training engine 220 may be updating internal weights and/or layers of the neural network in training 224. The training engine 220 may also be configured to add a classification layer to the trained neural network 132. Alternatively, the method 300 may be used to train a model from scratch. Training of a model from scratch may benefit from using many data sources 112 and many different types of machines 204a-N, each of which provide different types of training data 208a-N.

Whether fine-tuning a pre-trained model or starting from scratch, the method 300 may begin by obtaining initial training data 208a-N (step 304). The training data 208a-N may be received from one or more machines 204a-N of different types. While FIG. 2 illustrates more than three different types of machines 204a-N, it should be appreciated that the training data 208a-N may come from a greater or lesser number of different types of machines 204a-N. In some embodiments, the number N of different types of machines may correspond to an integer value that is greater than or equal to one. Furthermore, the number of types of training data does not necessarily need to equal the number N of different types of machines. For instance, two different types of machines may be configured to produce the same or similar types of training data.

The method 300 may continue by determining if any additional training data or different types of training data 208a-N are desired for the neural network in training 224 (step 308). If this query is answered positively, then the additional training data 208a-N is obtained from the appropriate data source 112, which may correspond to a different type of machine 204a-N than provided the initial training data.

Thereafter, or if the query of step 308 is answered negatively, the method 300 continues with the tokenizer 212 tokenizing the training data and producing a tokenized input 216 for the training engine 220 (step 316). It should be appreciated that the tokenizing step may correspond to an optional step and is not required to sufficiently train a neural network in training 224. In some embodiments, the tokenizer 212 may be configured to provide a tokenized input 216 that tokenizes the training data by embedding, split words, and/or positional encoding.

The method 300 may also include an optional step of dividing the training data into data log pieces (step 320). The size of the data log pieces may be selected based on a maximum size of memory 128 that will eventually be used in the processing system 108. The optional dividing step may be performed before or after the training data has been tokenized by the tokenizer 212. For instance, the tokenizer 212 may receive training data 208a-N that has already been dividing into data log pieces of an appropriate size. In some embodiments, it may be possible to provide the training engine 220 with log pieces of different sizes.

In addition to optionally adjusting the size of data log pieces used to train the neural network in training 224, the method 300 may also provide the ability to adjust other training parameters. Thus, the method 300 may continue by determining whether or not other adjustments will be used for training the neural network in training 224 (step 324). Such adjustments may include, without limitation, adjusting a training by: (i) shuffling training data 228; (ii) varying a start point of the training data 232; (iii) degrading at least some of the training data 236 (e.g., injecting errors into the training data or erasing some portions of the training data); and/or (iv) varying lengths of the training data or portions thereof 240 (step 328).

The training engine 220 may train the neural network in training 224 on the various types of training data 208a-N until it is determined that the neural network in training 224 is sufficiently trained (step 332). The determination of whether or not the training is sufficient/complete may be based on a timing component (e.g., whether or not the neural network in training 224 has been training on the training data 208a-N for at least a predetermined amount of time). Alternatively or additionally, the determination of whether or not the training is sufficient/complete may include analyzing a performance of the neural network in training 224 with a new data log that was not included in the training data 208a-N to determine if the neural network in training 224 is capable of parsing the new data log with at least a minimum required accuracy. Alternatively or additionally, the determination of whether or not the training is sufficient/complete may include requesting and receiving human input that indicates the training is complete. If the inquiry of step 332 is answered negatively, then the method 300 continues training (step 336) and reverts back to step 324.

If the inquiry of step 332 is answered positively, then the neural network in training 224 may be output by the training engine 220 as a trained neural network 132 and may be stored in memory 128 for subsequent processing of data logs from data sources 112 (step 340). In some embodiments, additional feedback (human feedback or automated feedback) may be received based on the neural network 132 processing/parsing actual data logs. This additional feedback may be used to further train or fine tune the neural network 132 outside of a formal training process (step 344).

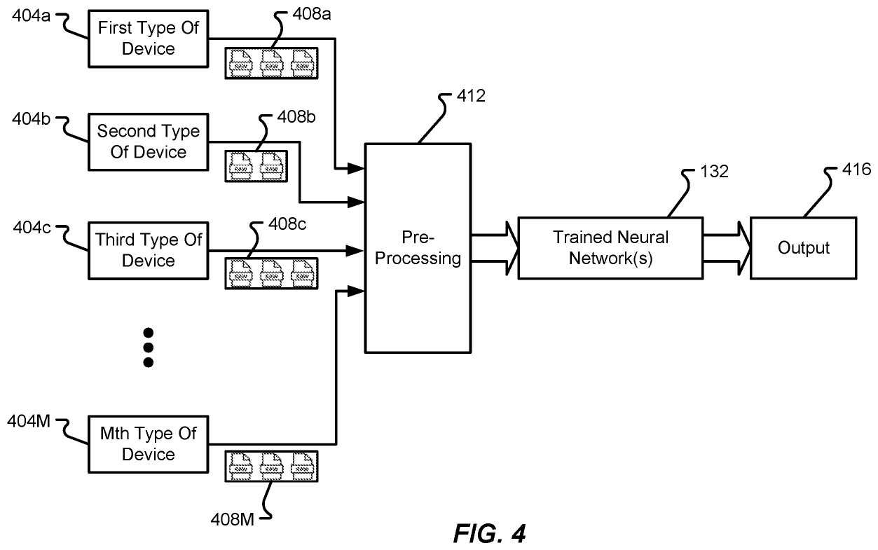

Referring now to FIGS. 4-6, additional details of utilizing a trained neural network 132 or multiple trained neural networks 132 to process or parse data logs from data sources 112 will be described in accordance with at least some embodiments of the present disclosure. FIG. 4 illustrates an illustrative architecture in which the trained neural network(s) 132 may be employed. In the depicted example, a plurality of different types of devices 404a-M provide data logs 408a-M to the trained neural network(s) 132. The different types of devices 404a-M may or may not correspond to different data sources 112. In some embodiments, the first type of device 404a may be different from the second type of device 404b and each device may be configured to provide data logs 408a, 408b, respectively, to the trained neural network(s) 132. As discussed above, the neural network(s) 132 may have been trained to process language-based inputs and, in some embodiments, may include an NLP machine learning model.

One, some, or all of the data logs 408a-M may be received in a format that is native to the type of device 404a-M that generated the data logs 408a-M. For instance, the first data log 408a may be received in a format native to the first type of device 404a (e.g., a raw data format), the second data log 408b may be received in a format native to the second type of device 404b, the third data log 408c may be received in a format native to the third type of device 404c, . . . , and the Mth data log 408M may be received in a format native to the Mth type of device 404M, where M is an integer value that is greater than or equal to one. The data logs 408a-M do not necessarily need to be provided in the same format. Rather, one or more of the data logs 408a-M may be provided in a different format from other data logs 408a-M.

The data logs 408a-M may correspond to complete data logs, partial data logs, degraded data logs, raw data logs, or combinations thereof. In some embodiments, one or more of the data logs 408a-M may correspond to alternative representations or structured transformations of a raw data log. For instance, one or more data logs 408a-M provided to the neural network(s) 132 may include deduplicated data logs, summarizations of data logs, scrubbed data logs (e.g., data logs having sensitive/Personally Identifiable Information (PII) information removed therefrom or obfuscated), combinations thereof, and the like. In some embodiments, one or more of the data logs 408a-M are received in a data stream directly from the data source 112 that generates the data log. For example, the first type of device 404a may correspond to a data source 112 that transmits the first data log 408a as a data stream using any type of communication protocol suitable for transmitting data logs across the communication network 104. As a more specific, but non-limiting, example, one or more of the data logs 408a-M may correspond to a cyber log that includes security data communicated from one machine to another machine across the communication network 104.

Because the data log(s) 408a-M may be provided to the neural network 132 in a native format, the data log(s) 408a-M may include various types of data or data fields generated by a machine that communicates via the communication network 104. Illustratively, one or more of the data log(s) 408a-M may include a file path name, an Internet Protocol (IP) address, a Media Access Control (MAC) address, a timestamp, a hexadecimal value, a sensor reading, a username, an account name, a domain name, a hyperlink, host system metadata, duration of connection information, communication protocol information, communication port identification, and/or a raw data payload. The type of data contained in the data log(s) 408a-M may depend upon the type of device 404a-M generating the data log(s) 408a-M. For instance, a data source 112 that corresponds to a communication endpoint may include application information, user behavior information, network connection information, etc. in a data log 408 whereas a data source 112 that corresponds to a network device or network border device may include information pertaining to network connectivity, network behavior, Quality of Service (QoS) information, connection times, port usage, etc.

In some embodiments, the data log(s) 408a-M may first be provided to a pre-processing stage 412. The pre-processing stage 412 may be configured to tokenize one or more of the data logs 408a-M prior to passing the data logs to the neural network 132. The pre-processing stage 412 may include a tokenizer, similar to tokenizer 212, which enables the pre-processing stage 412 to tokenize the data log(s) 408a-M using word embedding, split words, and/or positional encoding.

The pre-processing stage 412 may also be configured to perform other pre-processing tasks such as dividing a data log 408 into a plurality of data log pieces and then providing the data log pieces to the neural network 132. The data log pieces may be differently sized from one another and may or may not overlap one another. For instance, one data log piece may have some amount of overlap or common content with another data log piece. The maximum size of the data log pieces may be determined based on memory 128 limitations and/or processor 116 limitations. Alternatively or additionally, the size of the data log pieces may be determined based on a size of training data 232 used during the training of the neural network 132. The pre-processing stage 412 may alternatively or additionally be configured to perform pre-processing techniques that include deduplication processing, summarization processing, sensitive data scrubbing/obfuscation, etc.

It should be appreciated that the data log(s) 408a-M do not necessarily need to be complete or without degradation. In other words, if the neural network 132 has been adequately trained, it may be possible for the neural network 132 to successfully parse incomplete data logs 408a-M and/or degraded data logs 408a-M that lack at least some information that was included when the data logs 408a-M were generated at the data source 112. Such losses may occur because of network connectivity issues (e.g., lost packets, delay, noise, etc.) and so it may be desirable to train the neural network 132 to accommodate the possibility of imperfect data logs 408a-M.

The neural network 132 may be configured to parse the data log(s) 408a-M and build an output 416 that can be stored in the data log repository 140.l As an example, the neural network 132 may provide an output 416 that includes reconstituted full key/value values of the different data logs 408a-M that have been parsed. In some embodiments, the neural network 132 may parse data logs 408a-M of different formats, whether such formats are known or unknown to the neural network 132, and generate an output 416 that represents a combination of the different data logs 408a-M. Specifically, as the neural network 132 parses different data logs 408a-M, the output produced by the neural network 132 based on parsing each data log 408a-M may be stored in a common data format as part of the combined data log 144.

In some embodiments, the output 416 of the neural network 132 may correspond to an entry for the combined data log 144, a set of entries for the combined data log 144, or new data to be referenced by the combined data log 144. The output 416 may be stored in the combined data log 144 so as to enable the processor 116 to execute the data log evaluation 136 and search the combined data log 144 for actionable events.

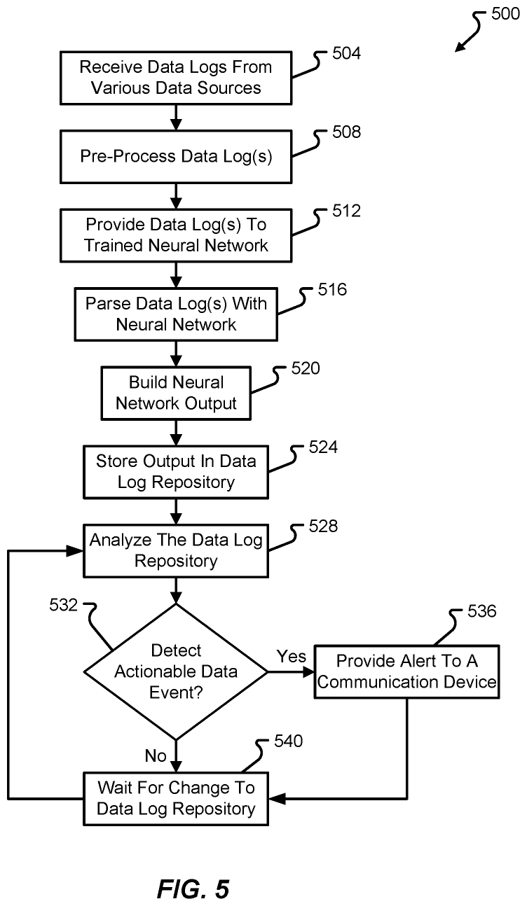

With reference now to FIGS. 4 and 5, a method 500 of processing data logs 408a-M will be described in accordance with at least some embodiments of the present disclosure. The method 500 may begin by receiving data logs 408a-M from various data sources 112 (step 504). One or more of the data sources 112 may correspond to a first type of device 404a, others of the data sources 112 may correspond to a second type of device 404b, others of the data sources 112 may correspond to a third type of device 404c, . . . , while still others of the data sources 112 may correspond to an Mth type of device 404M. The different data sources 112 may provide data logs 408a-M of different types and/or formats, which may be known or unknown to the neural network 132.

The method 500 may continue with the pre-processing of the data log(s) 408a-M at the pre-processing stage 412 (step 508). Pre-processing may include tokenizing one or more of the data logs 408a-M and/or dividing one or more data logs 408a-M into smaller data log pieces. The pre-processed data logs 408a-M may then be provided to the neural network 132 (step 512) where the data logs 408a-M are parsed (step 516).

Based on the parsing step, the neural network 132 may build an output 416 (step 520). The output 416 may be provided in the form of a combined data log 144, which may be stored in the data log repository 140 (step 524).

The method 500 may continue by enabling the processor 116 to analyze the data log repository 140 and the data contained therein (e.g., the combined data log 144) (step 528). The processor 116 may analyze the data log repository 140 by executing the data log evaluation 136 stored in memory 128. Based on the analysis of the data log repository 140 and the data contained therein, the method 500 may continue by determining if an actionable data event has been detected (step 532). If the query is answered positively, then the processor 116 may be configured to generate an alert that is provided to a communication device 148 operated by a system administrator 152 (step 536). The alert may include information describing the actionable data event, possibly including the data log 408 that triggered the actionable data event, the data source 112 that produced the data log 408 that triggered the actionable data event, and/or whether any other data anomalies have been detected with some relationship to the actionable data event.

Thereafter, or in the event that the query of step 532 is answered negatively, the method 500 may continue with the processor 116 waiting for another change in the data log repository 140 (step 540), which may or may not be based on receiving a new data log at step 504. In some embodiments, the method may revert back to step 504 or to step 528.

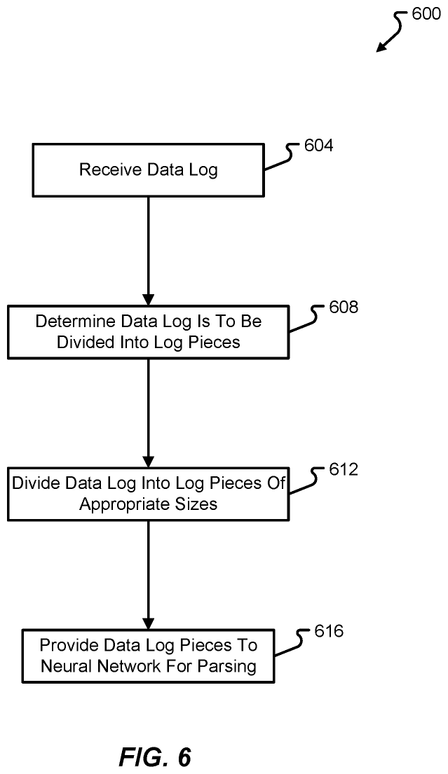

Referring now to FIG. 6, a method 600 of pre-processing data logs 408 will be described in accordance with at least some embodiments of the present disclosure. The method 600 may begin when one or more data logs 408a-M are received at the pre-processing stage 412 (step 604). The data logs 408a-M may correspond to raw data logs, parsed data logs, degraded data logs, lossy data logs, incomplete data logs, or the like. In some embodiments, the data log(s) 408a-M received in step 604 may be received as part of a data stream (e.g., an IP data stream).

The method 600 may continue with the pre-processing stage 412 determining that at least one data log 408 is to be divided into log pieces (step 608). Following this determination, the pre-processing stage 412 may divide the data log 408 into log pieces of appropriate sizes (step 612). The data log 408 may be divided into equally sized log pieces or the data log 408 may be divided into log pieces of different sizes.

Thereafter, the pre-processing stage 412 may provide the data log pieces to the neural network 132 for parsing (step 616). In some embodiments, the size and variability of the data log pieces may be selected based on the characteristics of training data 208a-N used to train the neural network 132.

Specific details were given in the description to provide a thorough understanding of the embodiments. However, it will be understood by one of ordinary skill in the art that the embodiments may be practiced without these specific details. In other instances, well-known circuits, processes, algorithms, structures, and techniques may be shown without unnecessary detail in order to avoid obscuring the embodiments.

While illustrative embodiments of the disclosure have been described in detail herein, it is to be understood that the inventive concepts may be otherwise variously embodied and employed, and that the appended claims are intended to be construed to include such variations, except as limited by the prior art.

What is claimed is:

1. A method for processing data logs, the method comprising:
receiving a data log from a data source, wherein the data log is received in a format native to a machine that generated the data log;
providing the data log to a neural network trained to process natural language-based inputs;
parsing the data log with the neural network;
receiving an output from the neural network, wherein the output from the neural network is generated in response to the neural network parsing the data log; and
storing the output from the neural network in a data log repository.

2. The method of claim 1, further comprising:
receiving an additional data log from an additional data source, wherein the additional data source is different from the data source, and wherein the additional data log is received in a second format native to the additional data source;
providing the additional data log to the neural network;
parsing the additional data log with the neural network;
receiving an additional output from the neural network, wherein the additional output from the neural network is generated in response to the neural network parsing the additional data log; and
storing the additional output from the neural network in the data log repository.

3. The method of claim 2, wherein the output and the additional output are stored in the data log repository in a common data format as part of a combined data log.

4. The method of claim 2, wherein the additional data log is received as a data stream directly from the additional data source.

5. The method of claim 2, wherein the machine that generated the data log comprises a first type of device, wherein the additional data source comprises a second type of device, and wherein the first type of device and second type of device belong to a common network infrastructure.

6. The method of claim 1, wherein the machine that generated the data log comprises at least one of a communication endpoint, a network device, a network border device, a security device, and a sensor.

7. The method of claim 1, wherein the data log comprises security data communicated from the machine to another machine and wherein the neural network comprises a Natural Language Processing (NLP) machine learning model.

8. The method of claim 1, further comprising:
dividing the data log into a plurality of data log pieces; and
providing the plurality of data log pieces to the neural network, wherein the neural network is trained with training data that comprises log pieces, and wherein a size of one log piece in the plurality of data log pieces is different from a size of another log piece in the plurality of data log pieces.

9. The method of claim 1, further comprising:
analyzing the data log repository;
based on the analysis of the data log repository, detecting an actionable data event; and
providing an alert to a communication device, wherein the alert comprises information describing the actionable data event.

10. The method of claim 1, wherein the data log comprises at least one of a file path name, an Internet Protocol (IP) address, a Media Access Control (MAC) address, a timestamp, a hexadecimal value, a sensor reading, username, account name, domain name, hyperlink, host system metadata, duration of connection, communication protocol, communication port, and raw payload.

11. The method of claim 1, wherein the data log comprises at least one of a degraded log and an incomplete log.

12. A system for processing data logs, comprising:
a processor; and
memory coupled with the processor, wherein the memory stores data that, when executed by the processor, enables the processor to:
receive a data log from a data source, wherein the data log is received in a format native to a machine that generated the data log;
parse the data log with a neural network trained to process natural language-based inputs; and
store an output from the neural network in a data log repository, wherein the output from the neural network is generated in response to the neural network parsing the data log.

13. The system of claim 12, wherein the data stored in memory further enables the processor to tokenize the data log prior to parsing the data log with the neural network.

14. The system of claim 12, wherein the data stored in memory further enables the processor to:
receive an additional data log from an additional data source, wherein the additional data source is different from the data source, and wherein the additional data log is received in a second format native to the additional data source;
parse the additional data log with the neural network; and
store an additional output from the neural network in the data log repository, wherein the additional output from the neural network is generated in response to the neural network parsing the additional data log.

15. The system of claim 14, wherein the output and the additional output are stored in the data log repository in a common data format as part of a combined data log.

16. The system of claim 14, wherein the additional data log is received as a data stream directly from the additional data source.

17. The system of claim 14, wherein the machine that generated the data log comprises a first type of device, wherein the additional data source comprises a second type of device, and wherein the first type of device and second type of device belong to a common network infrastructure.

18. The system of claim 12, wherein the data log comprises security data communicated from the machine to another machine and wherein the neural network comprises a Natural Language Processing (NLP) machine learning model.

19. The system of claim 12, wherein the data stored in memory further enables the processor to:
analyze the data log repository;
based on the analysis of the data log repository, detect an actionable data event; and
provide an alert to a communication device, wherein the alert comprises information describing the actionable data event.

20. The system of claim 12, wherein at least one of the processor and memory are provided in a Graphics Processing Unit (GPU).

21. The system of claim 12, wherein the data log comprises at least one of a degraded log and an incomplete log.

22. A method of training a system for processing data logs, the method comprising:
providing a neural network with first training data, wherein the neural network comprises a Natural Language Processing (NLP) machine learning model and wherein the first training data comprises a first data log generated by a first type of machine;
providing the neural network with second training data, wherein the second training data comprises a second data log generated by a second type of machine;
determining that the neural network has trained on the first training data and the second training data for at least a predetermined amount of time; and
storing the neural network in computer memory such that the neural network is made available to process additional data logs.

23. The method of claim 22, wherein the first data log comprises at least one of a raw data log and a parsed data log, wherein the first data log is tokenized with at least one of word embedding, split words, and positional encoding, and wherein the method further comprises:
adjusting a training of the neural network by at least one of: (i) shuffling the first training data and second training data; (ii) varying a start point of the first training data; (iii) varying a start point of the second training data; and (iv) degrading at least one of the first training data and second training data.

24. A processor, comprising:
one or more circuits to use one or more natural language-based neural networks to parse one or more machine-generated data logs.

25. The processor of claim 24, wherein the one or more circuits are configured to:
receive the one or more machine-generated data logs from a data source; and
generate an output in response to parsing the one or more machine-generated data logs, wherein the output is configured to be stored as part of a data log repository.

26. The processor of claim 24, wherein the one or more machine-generated data logs are received as part of a data stream.

27. The processor of claim 24, wherein the one or more machine-generated data logs comprise at least one of a degraded log, an incomplete log, a deduplicated log, a log summarization, a log having sensitive information obfuscated, and a partial data log.
